(19) United States
(12) Patent Application Publication
(10) Pub. No.: US 2016/0344039 A1
(43) Pub. Date: Nov. 24, 2016

(54) LITHIUM PRIMARY BATTERY

(71) Applicant: PANASONIC INTELLECTUAL PROPERTY MANAGEMENT CO., LTD., Osaka-shi (JP)

(72) Inventors: YOKO SANO, Osaka (JP); TOMOHIRO UEDA, Osaka (JP)

(21) Appl. No.: 15/110,984

(22) PCT Filed: Feb. 12, 2015
(86) PCT No.: PCT/JP2015/000626

§ 371 Date: Jul. 12, 2016

(30) Foreign Application Priority Data
Mar. 18, 2014 (JP) 2014-054964

(51) Int. Cl. H01M 6/16; H01M 2/02; H01M 4/40; H01M 4/62; H01M 4/06; H01M 4/58

(52) U.S. Cl. CPC H01M 6/16; H01M 4/06; H01M 4/5825; H01M 4/405; H01M 4/625; H01M 2/0222

(57) ABSTRACT

A lithium primary battery including a negative electrode including metal lithium and/or a lithium alloy, a positive electrode including a positive electrode active material, a separator interposed between the negative electrode and the positive electrode, and a nonaqueous electrolyte. The positive electrode active material includes Fe₂(SO₄)₃. The negative electrode has a coating layer on a facing surface facing the positive electrode, and the coating layer includes a powder or fibrous material.

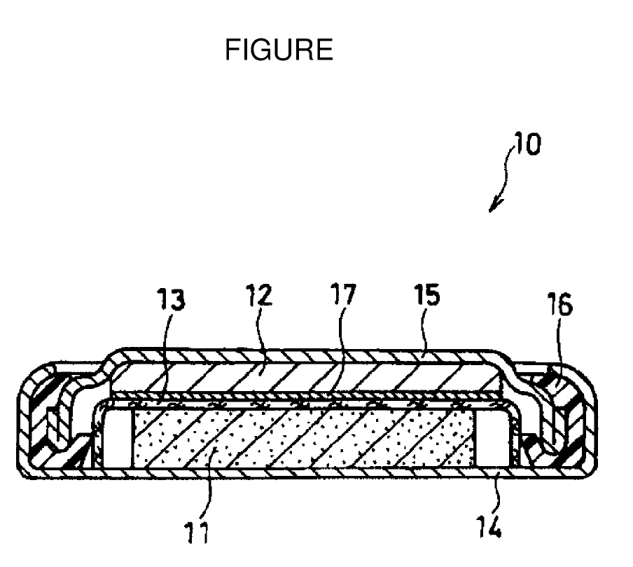

### TECHNICAL FIELD

The present invention relates to a lithium primary battery, and more particularly, mainly to improvement of high-temperature storage characteristics of a lithium primary battery.

### BACKGROUND ART

Lithium primary batteries have high electromotive force and a high energy density, and therefore are widely used as a main power source and a backup power source for electronic devices such as portable devices and vehicle-mounted electronic devices. In general, lithium primary batteries include a positive electrode including a positive electrode active material such as manganese dioxide and carbon fluoride, a negative electrode including lithium and/or a lithium alloy, a separator for separating the positive electrode from the negative electrode, and a nonaqueous electrolyte that is in contact with the positive electrode, the negative electrode, and the separator.

It is considered that elution of metal ions (for example, Mn²⁺ ions) contained in a positive electrode active material (for example, MnO₂) occurs during storage of a lithium primary battery. However, it has not been reported that Mn²⁺ ions are deposited on a surface of a negative electrode to form a dendritic crystal (dendrite) of manganese, thus causing a short circuit. It is considered that manganese is deposited, but a dendritic crystal that is so sharp as to penetrate through the separator is not formed.

However, it is known that polarization is increased at the initial time of discharge in a lithium battery using metal lithium and/or a lithium alloy for a negative electrode. Thus, PTL 1 proposes that a powdery carbon material be attached to a surface of the negative electrode.

Furthermore, PTL 2 proposes that Fe₂(SO₄)₃ be used as a positive electrode active material in order to obtain a lithium secondary battery having large reversible capacity.

### CITATION LIST

### Patent Literature

PTL 1: Japanese Patent Application Unexamined Publication No. H11-135116
PTL 2: Japanese Patent Application Unexamined Publication No. H6-119926

### SUMMARY OF THE INVENTION

### Problems to be Solved by the Invention

With diversification of electronic devices using a lithium primary battery as a power source, the lithium primary battery has been required to have higher electromotive force. In this point, for example, when a lithium primary battery is used as a power source of an electronic device having a drive voltage of 3 V or more, a plurality of lithium primary batteries are generally connected in series or a booster circuit is used. However, this method has a demerit that costs are increased.

It is an object of the present invention to increase electromotive force and to improve high-temperature storage characteristics in a lithium primary battery including a negative electrode including metal lithium and/or a lithium alloy.

### Means to Solve the Problem

An aspect of the present invention relates to a lithium primary battery including a negative electrode including metal lithium and/or a lithium alloy, a positive electrode including a positive electrode active material, a separator interposed between the negative electrode and the positive electrode, and a nonaqueous electrolyte. The positive electrode active material includes Fe₂(SO₄)₃. The negative electrode has a coating layer on a facing surface facing the positive electrode, and the coating layer includes a powder or fibrous material.

The coating layer includes preferably a conductive material, more preferably a carbon material, and particularly preferably at least one selected from the group consisting of carbon black and graphite. Furthermore, the separator preferably includes a nonwoven fabric.

### Advantageous Effect of Invention

The present invention provides a lithium primary battery having a negative electrode including metal lithium and/or a lithium alloy, in which high electromotive force and excellent high-temperature storage characteristics are achieved.

### BRIEF DESCRIPTION OF THE DRAWINGS

FIGURE is a schematic longitudinal sectional view of a coin-type lithium primary battery in accordance with one exemplary embodiment of the present invention.

### DETAILED DESCRIPTION OF THE PREFERRED EMBODIMENT

Hereinafter, the present invention is described in detail with reference to a drawing showing one exemplary embodiment of the present invention.

FIGURE is a longitudinal sectional view schematically showing a coin-type lithium primary battery in accordance with one exemplary embodiment of the present invention. Coin-type lithium primary battery 10 includes positive electrode 11, negative electrode 12, and separator 13 disposed between positive electrode 11 and negative electrode 12. Furthermore, positive electrode 11, negative electrode 12, and separator 13 are in contact with a nonaqueous electrolyte (not shown).

### Positive Electrode

Positive electrode 11 is a disk-shaped pellet of a positive electrode material mixture, and one surface of positive electrode 11 is electrically connected to positive electrode case 14. The positive electrode material mixture includes Fe₂(SO₄)₃ as a positive electrode active material, and further includes additives such as a conductive agent, and a binder, if necessary.

The present inventors have attempted to use Fe₂(SO₄)₃, proposed in PTL 2, as a positive electrode active material of a lithium primary battery. Fe₂(SO₄)₃ is used because it is highly safe, can achieve a high voltage, and is available inexpensively. However, it has been found that Fe ions eluted from the positive electrode are deposited on the surface of the negative electrode to form sharp dendritic dendrites, causing a serious short circuit, unlike a case where, for example, MnO₂ is used as the positive electrode active material.

As a result of intensive study, it has been found that providing a coating layer on a surface of the negative electrode suppresses deposition of dendritic crystals (dendrites) of Fe on the surface of the negative electrode although the reason therefor is not ensured. That is to say, the present invention includes Fe₂(SO₄)₃ as a positive electrode active material, and provides a coating layer including a powder or fibrous material on a facing surface of the negative electrode facing the positive electrode, thereby achieving a lithium primary battery having excellent high-temperature storage characteristics and high electromotive force. Note here that as in PTL 1, in the field of lithium batteries, attaching a powdery carbon material onto the surface of the negative electrode has been already proposed. In this case, however, the positive electrode active material is, for example, fluorinated graphite or MnO₂, and a short circuit due to dendrites derived from the positive electrode active material does not occur. Therefore, a carbon powder layer is provided on the surface of the negative electrode not for suppressing a short circuit, but for enhancing the activity of the negative electrode. On the other hand, when Fe₂(SO₄)₃ is used as the positive electrode active material, providing a coating layer remarkably reduces a short circuit due to dendrites of Fe regardless of the activity of the negative electrode.

The positive electrode active material may include, in addition to Fe₂(SO₄)₃, various active materials well known in the field of lithium primary batteries. Specifically, carbon fluoride and a metal compound can be used. Examples of the metal compound include oxides such as MnO₂, MoO₃, V₂O₅, and Mn₂O₄, metallic sulfides such as TiS₂ and MoS₂, and the like. These may be used alone or in combination of two or more thereof. It is preferable that Fe₂(SO₄)₃ is included at 70 mass % or more relative to the total of the positive electrode active material from the viewpoint of easiness in obtaining higher electromotive force. Furthermore, an average particle diameter of Fe₂(SO₄)₃ is not particularly limited.

The conductive agent included in the positive electrode material mixture includes an agent which does not cause a chemical reaction in a potential range of the positive electrode active material during discharge. Specific examples thereof include graphite, carbon black, carbon fiber, metal fiber, organic conductive material, and the like. These may be used alone or in combination of two or more thereof. The content ratio of the conductive agent in the positive electrode mixture material is not particularly limited, and the ratio is, for example, 30 parts by mass or less, and preferably 5 to 30 parts by mass relative to 100 parts by mass of the positive electrode active material.

The binder included in the positive electrode material mixture includes one which does not cause a chemical change in a potential range of the positive electrode active material during discharge. Specific examples thereof include fluororesin such as polyvinylidene fluoride and polytetrafluoroethylene, fluorine rubber, styrene-butadiene rubber (SBR), polyacrylic acid, and the like.

Herein, when the positive electrode material mixture is formed, the positive electrode active material, the binder, the conductive agent, and the like, are usually kneaded in the presence of an organic solvent or water. Water is preferably used in view of handling and environmental load when water does not influence the properties of the positive electrode active material. Fe₂(SO₄)₃ is not changed in properties even when it is kneaded with water, but it has high moisture absorption property. Therefore, when kneading is carried out in the presence of water, in order to remove moisture absorbed by Fe₂(SO₄)₃, the positive electrode including Fe₂(SO₄)₃ is dried at high temperature before fabrication of the battery. It is therefore preferable that the binder included in the positive electrode material mixture has high heat resistance. It is preferable that the binder has heat resistance to a temperature of 200° C. or higher. From this viewpoint, as the binder, fluororesin is preferably used. Note here that when kneading is carried out in the presence of an organic solvent, it is carried out in the environment in which moisture of the positive electrode active material including Fe₂(SO₄)₃ is removed in advance and moisture is not absorbed. The binder may be alone or in combination of two or more binders. The content ratio of the binder in the positive electrode material mixture is not particularly limited, and it is preferably, for example, 3 to 15 parts by mass relative to 100 parts by mass of the positive electrode active material.

Positive electrode case 14 is a member for housing positive electrode 11, and separator 13 mentioned below, and further functions also as a positive current collector and a positive terminal. Examples of materials for forming positive electrode case 14 include various materials well known in the field of lithium primary batteries. Specific examples thereof may include titanium and stainless steel.

In the above description, it is assumed that positive electrode 11 is a disk-shaped pellet of a positive electrode material mixture, but the positive electrode of lithium primary battery is not limited thereto. For example, a positive electrode may be obtained by dispersing or dissolving the above-mentioned positive electrode material mixture in an appropriate liquid component such as water and N-methyl-2-pyrrolidone (NMP), and then applying the resultant slurry onto the surface of the current collector (core material) such as an Al foil, followed by drying thereof. Furthermore, a positive electrode may be obtained by adding appropriate liquid components such as water to the above-mentioned positive electrode material mixture so that the resultant mixture has appropriate viscosity, and then embedding the mixture into, for example, a stainless steel lath material or mesh material, and drying thereof.

### Negative Electrode

Negative electrode 12 is a disk-shaped metal lithium and/or a lithium alloy, and one surface of negative electrode 12 is electrically connected to negative electrode case 15. A surface of negative electrode 12 opposite to a negative electrode case 15 side is a facing surface facing positive electrode 11. On this facing surface, coating layer 17 is formed.

For the lithium alloy, various lithium alloys known in the field of lithium primary batteries may be used. Examples of lithium alloys include aluminum (Al), tin (Sn), magnesium (Mg), indium (In), calcium (Ca), manganese (Mn), and the like. Such metal that can be alloyed with lithium may be included alone in the lithium alloy or two or more of types of metal may be included in the lithium alloy.

The physical properties and surface states of the lithium alloy can be improved as compared with those of metal lithium by appropriately adjusting the content ratio of metal to be alloyed with lithium. The content ratio of the metal to be alloyed with lithium is not particularly limited, and it is preferably 5 mass % or less with respect to the total of the lithium alloy. In this range, the melting point or rigidity of the lithium alloy can be made appropriate, thus improving the processability of negative electrode 12.

The metal lithium and/or the lithium alloy is molded into any shapes and thicknesses corresponding to the shapes, dimensions, specifications and performance, and the like, of finally obtained lithium primary batteries as in negative electrodes for conventional lithium primary batteries. Examples of the shape thereof include a sheet shape and a disk shape. Specifically, when the lithium primary battery is a coin-type battery, the metal lithium and/or the lithium alloy may be molded into a disk shape having a diameter of about 3 mm to 25 mm and a thickness of about 0.2 mm to 2.0 mm.

### Coating Layer

Coating layer 17 is formed on a facing surface of negative electrode 12 facing positive electrode 11. Coating layer 17 includes a powder or fibrous material (hereinafter, referred to as a coating material). The coating material may include ceramic, a conductive material, and the like. Among them, it is preferable that the coating material includes a conductive material from the viewpoint of reducing the internal resistance. The conductive material may include a carbon material such as carbon black, graphite, carbon nanofiber, and carbon nanotube; a conductive fiber obtained by, for example, dispersing graphite or the like in a synthetic fiber. Among the conductive materials, it is preferable that at least one selected from the group consisting of carbon black and graphite is used because it has particularly high conductivity.

Specific examples of the carbon black include acetylene black, ketjen black, contact black, furnace black, lamp black, and the like. These carbon blacks can be used alone or in combination of two or more of them. Specific examples of graphite include artificial graphite and natural graphite. Examples of artificial graphite include high purity graphite and highly crystalline graphite. The graphite can be used alone or in combination of two or more of them. Furthermore, one type or two or more types of carbon blacks and one type or two or more types of graphites can be used in combination.

Coating layer 17 can be formed by, for example, covering one side (a face of negative electrode 12 facing positive electrode 11) of a lithium plate or a lithium alloy plate of negative electrode 12 with a coating material, and compression-bonding thereof. Coating layer 17 is only required to be formed on at least a part of the facing surface of negative electrode 12 facing positive electrode 11. For example, coating layer 17 may be formed so as to cover the entire surface of the facing surface of negative electrode 12 facing positive electrode 11, or may be formed so as to cover entire surfaces including the side surfaces of negative electrode 12. Furthermore, an area of coating layer 17 may be made larger than an area of the facing surface of negative electrode 12 facing positive electrode 11. Coverage (an area rate) of the facing surface of negative electrode 12 facing positive electrode 11 with coating layer 17 is preferably 10 to 110%, and more preferably 10 to 100%. When the coverage is in the range, side reaction such as deposition of lithium on the surface of the negative electrode or accumulation of sulfuric acid compounds does not easily occur, and discharge characteristics are easily maintained. Furthermore, in the case of, for example, a wound type battery produced in which a positive electrode and a negative electrode are wound together, a coating layer may be formed on both surfaces of a sheet-like negative electrode.

When the coating material is a powdery material, the average particle diameter (a median diameter in the particle size distribution on the basis of volume) is preferably 5 nm to 100 μm, more preferably 30 nm to 10 μm, and most preferably 30 nm to 1 μm. When the average particle diameter of a powdery coating material is in this range, the high-temperature storage characteristics are easily improved.

When the coating material is a fibrous material, the diameter is preferably 10 nm to 10 μm, and more preferably 50 nm to 1 μm. Furthermore, the length is preferably 0.1 μm to 100 μm, and more preferably 1 μm to 50 μm. When the diameter and length of the fibrous coating material are in the range, the high-temperature storage characteristics are easily improved.

Coating layer 17 may be formed after metal lithium and/or a lithium alloy is molded into, for example, a disk shape having a predetermined diameter by punching. Furthermore, coating layer 17 may be formed on a surface of pre-molded metal lithium and/or lithium alloy. In this case, metal lithium and/or a lithium alloy provided with coating layer 17 is punched into a disk shape having a predetermined diameter to thus mold disk-shaped negative electrode 12, and negative electrode 12 is disposed inside negative electrode case 15 such that coating layer 17 faces positive electrode 11. Furthermore, coating layer 17 may be formed at the same time when the metal lithium and/or lithium alloy is molded into a disk shape. In this case, a predetermined amount of lump-shaped (for example, cube-shaped or ball-shaped) metal lithium and/or lithium alloy is disposed between negative electrode case 15 and coating layer 17 that has been molded in a predetermined size in advance, followed by pressurization. Thus, at the same time when the metal lithium and/or lithium alloy is compression-bonded to the inner surface of negative electrode case 15, coating layer 17 is formed.

As a method for forming coating layer 17 on the surface of the metal lithium and/or the lithium alloy, for example, various well-known methods for covering a surface of a base material with powder can be employed. Furthermore, the powdery coating material may be fixed to the surface of metal lithium and/or a lithium alloy by pressure compression-bonding, ultrasonic-compression bonding, and the like. Furthermore, a coating material is molded in a sheet shape, and compression-bonded to the surface of metal lithium and/or a lithium alloy. Furthermore, a coating material may be applied to an appropriate base material and then the base material may be transferred to the surface of metal lithium and/or a lithium alloy.

A thickness of coating layer 17 is not particularly limited, and it is preferably 1 μm to 100 μm, and more preferably 10 μm to 80 μm. Furthermore, coating layer 17 may be limited based not on the thickness of the coating material but on the amount thereof. In this case, the attached amount of coating materials per cm² of the metal lithium and/or lithium alloy is not particularly limited, and it is preferably 0.1 mg to 10 mg, and more preferably 0.3 mg to 2 mg.

### Negative Electrode Case

Negative electrode case 15 is a member that is brought into contact with negative electrode 12, and works as a negative electrode current collector or a negative electrode terminal. Negative electrode case 15 further functions as a sealing plate of a coin-type battery. Formation materials of negative electrode case 15 include various materials well known in the field of lithium primary batteries. Specific examples thereof include iron, titanium, stainless steel, and the like.

### Separator

For the separator 13, a porous membrane made of a material having resistance to the internal environment of a lithium primary battery can be used. Specific examples thereof include a nonwoven fabric made of synthetic resin, porous films (microporous films) made of synthetic resin, and the like. Examples of the synthetic resin used for the nonwoven fabric include polyethylene, polypropylene, polyphenylene sulfide, polybutylene terephthalate, and the like. Among them, polypropylene is preferable. Examples of the synthetic resin used for the porous films include polyethylene, polypropylene, and the like. Among them, polyethylene is preferable.

A thickness of one nonwoven fabric to be used for separator 13 is preferably 30 μm to 200 μm, and more preferably 60 μm to 100 μm. A thickness of one porous film to be used for separator 13 is preferably 6 μm to 20 μm. When the thickness of the nonwoven fabric or the porous film is in the ranges, the discharge characteristics can be easily maintained and a short circuit can be easily suppressed. The above-mentioned nonwoven fabric and porous film can be used alone. That is to say, when a nonwoven fabric is used as separator 13 alone, the thickness of separator 13 may be 30 μm to 200 μm. When a porous film is used as separator 13 alone, the thickness of separator 13 may be 6 μm to 20 μm. Furthermore, a plurality of nonwoven fabrics or porous films of the same material type may be laminated, or a plurality of nonwoven fabrics or porous films of different material types may be combined. In addition, a nonwoven fabric and a porous film may be combined with each other. Among them, it is preferable that a plurality of nonwoven fabrics and/or porous films are laminated because an effect of suppressing a short circuit due to a pin-hole can be improved. When a plurality of nonwoven fabrics and other nonwoven fabrics and/or porous films are limited on each other, it is preferable that separator 13 is disposed such that the nonwoven fabric is brought into contact with positive electrode 11. The thickness of separator 13 in which a plurality of nonwoven fabrics and/or porous films are combined with each other is preferably 50 μm to 300 μm.

Among them, it is preferable that separator 13 includes a nonwoven fabric from the viewpoint of discharge characteristics. It is generally known that a porous film has a higher effect of suppressing a short circuit than a nonwoven fabric as a separator for a lithium primary battery or a lithium ion secondary battery. Therefore, for the separator, a porous film is mainly used. On the other hand, in the present invention, since coating layer 17 suppresses formation of Fe dendrites derived from Fe₂(SO₄)₃ as the positive electrode active material on the surface of the negative electrode, a nonwoven fabric can be used as a separator. In particular, in the present invention, it is preferable that nonwoven fabric is used as a separator, because the use of Fe₂(SO₄)₃ for the positive electrode active material causes a side reaction that sulfuric acid compounds may accumulate on the surface of the negative electrode. Also in this case, pores of the nonwoven fabric as the separator are not easily blocked, and discharge characteristics can be easily maintained. A mass per unit area of the nonwoven fabric used is preferably 15 to 60 g/m².

### Nonaqueous Electrolyte

A nonaqueous electrolyte includes a nonaqueous solvent and a solute dissolved in the nonaqueous solvent.

For the nonaqueous solvent, various solvents known in the field of lithium primary batteries may be used. Specific examples thereof include γ-butyrolactone, γ-valerolactone, propylene carbonate (PC), ethylene carbonate, butylene carbonate, vinylene carbonate, vinyl ethylene carbonate, 1,2-dimethoxyethane (DME), 1,2-diethoxy ethane, 1,3-dioxolane, dimethyl carbonate, diethyl carbonate, ethyl methylcarbonate, N,N-dimethylformamide, tetrahydrofuran, 2-methyltetrahydrofuran, dimethylsulfoxide, formamide, acetamide, dimethylformamide, acetonitrile, propionitrile, nitromethane, ethyl monoglyme, trimethoxy methane, dioxolane, dioxolane derivatives, sulfolane, methyl sulfolane, propylene carbonate derivatives, tetrahydrofuran derivatives, and the like. These may be used alone or in combination of two or more thereof. Among them, the nonaqueous solvent preferably includes PC. It is preferable because PC is stable in a wide temperatures range, and easily dissolves a solute. Furthermore, it is preferable to use PC and DME in combination. It is preferable because the viscosity of the nonaqueous electrolyte is reduced and a positive electrode material mixture is easily impregnated.

For the solute (supporting salt) used in the nonaqueous electrolyte, various solutes known in the field of lithium primary batteries may be used. Specific examples thereof include lithium hexafluorophosphate (LiPF₆), lithium perchlorate (LiClO₄), lithium tetrafluoroborate (LiBF₄), lithium trifluoromethylsulfonate (LiCF₃SO₃), lithium bis(trifluoromethylsulfonyl)imide (LiN(CF₃SO₂)₂), lithium bis(pentafluoroethylsulfonyl)imide (LiN(C₂F₅SO₂)₂), lithium (trifluoromethylsulfonyl)(nonafluorobutylsulfonyl)imide (LiN(CF₃SO₂)(C₄F₉SO₂)), lithium tris(trifluoromethylsulfonyl)methide (LiC(CF₃SO₂)₃), and the like. These solutes may be used alone or in combination of two or more of them. Among them, LiClO₄, is preferable because it is excellent in load property. Furthermore, combination of LiClO₄ and a small amount of LiBF₄ is more preferable from the view point that long-term stability is improved. When LiClO₄ and LiBF₄ are used in combination, the blending amount of LiBF₄ is not particularly limited, and it is preferably 1 to 10 mass % with respect to the nonaqueous electrolyte.

The solute concentration of nonaqueous electrolyte is not particularly limited, and it is preferably 0.5 to 1.5 mol/L. When the solute concentration is in the above-mentioned range, for example, discharge characteristics at room temperature and long-term storage characteristics are improved. Furthermore, the increase in the viscosity of the nonaqueous electrolyte and the decrease in ionic conductivity in a low temperature environment of about −40° C. can be suppressed.

### Gasket

Gasket 16 mainly insulates positive electrode case 14 from negative electrode case 15. Gasket 16 is made of, for example, a synthetic resin such as polypropylene, polyphenylene sulfide, and polyether ether ketone. Among them, polypropylene is preferable.

### Manufacturing Method

A lithium primary battery of the present invention is manufactured by a production method. The production method includes a first step of producing positive electrode 11 including a positive electrode active material containing, for example, Fe₂(SO₄)₃; a second step of forming a coating layer on negative electrode 12 including a metal lithium and/or a lithium alloy at a facing surface disposed to face positive electrode 11; a third step of forming an electrode assembly by laminating positive electrode 11, negative electrode 12, and separator 13 onto each other such that the facing surface of negative electrode 12 faces positive electrode 11, and positive electrode 11 and negative electrode 12 are separated from each other with separator 13; and a fourth step of bringing the above-mentioned negative electrode into contact with the nonaqueous electrolyte.

The first step and the fourth step in the above-mentioned steps can be carried out based on various methods well known in the field of lithium primary batteries. In the second step, it is preferable that the coating layer is formed by compression-bonding the coating material onto the surface of the negative electrode including metal lithium and/or a lithium alloy.

In the above description, it is assumed that the invention is applied to a coin-type lithium primary battery, but the lithium primary battery of the present invention is not limited thereto. The lithium primary battery may have any shapes appropriately selected from, for example, a cylindrical shape, a prismatic shape, a sheet shape, a flat shape, and a laminate shape, in addition to a coin shape, depending upon the applications, and the like, of the lithium primary battery.

Hereinafter, the present invention is specifically described based on Examples.

### Manufacture of Lithium Primary Battery

### Example 1

Coin-type lithium primary battery 10 as shown in FIGURE was manufactured according to the following procedures.

### (1) Preparation of Nonaqueous Electrolyte

PC and DME were mixed with each other in the volume ratio of 1:1. LiClO₄ was dissolved in the resultant mixture solvent (PC-DME solvent) to obtain a nonaqueous electrolyte containing LiClO₄ at a concentration of 0.5 mol/L (hereinafter, simply referred to as “LiClO₄/PC-DME”).

### (2) Production of Positive Electrode 11

NH₄Fe(SO₄)₂-6H₂O (reagent) was heat-treated at 500° C. for 27 hours to obtain Fe₂(SO₄)₃. The obtained Fe₂(SO₄)₃, acetylene black, and polytetrafluoroethylene (binder) were mixed at a mass ratio of 85:10:5. Water was added to the resultant mixture, and the resultant mixture was sufficiently kneaded so as to obtain a positive electrode material mixture. Next, this positive electrode material mixture was heated at 70° C. and dried. The dried positive electrode material mixture was filled in a mold, and pressure-molded by using a hydraulic press machine, to produce a pellet having a diameter of 15 mm and a thickness of 0.3 mm. The pellet was dried at 250° C. for 12 hours to obtain positive electrode 11.

### (3) Production of Negative Electrode 12

A lithium metal plate having a thickness of 0.3 mm was placed on an anvil of an ultrasonic vibration bonding machine. Onto a surface of the metal lithium plate, acetylene black (AB) powder (average particle diameter: 35 nm) was placed at a rate of 0.7 mg per cm² of the surface of the lithium metal plate, to form a layer composed of AB powder. Next, a horn of the ultrasonic vibration bonding machine was brought into contact with the layer composed of AB powder, and the metal lithium plate and the layer composed of AB powder were subjected to ultrasonic vibration, while they were pressurized. In such a manner, coating layer 17 made of AB powder was formed on the entire surface of the one side of the lithium metal plate. The coverage of one-side surface of negative electrode 12 with coating layer 17 was 100%. Finally, a lithium metal plate provided with coating layer 17 was punched into a circle having a diameter of 16 mm to thus obtain negative electrode 12. Note here that production of negative electrode 12 was carried out in dry air having a dew point of −50° C. or lower.

### (4) Fabrication of Lithium Primary Battery 10

Positive electrode 11 was disposed on the inner bottom surface of positive electrode case 14 made of stainless steel. Separator 13 was disposed on the surface of positive electrode 11. For separator 13, two nonwoven fabrics (thickness: 80 μm, mass per unit area: 22 g/m²) made of polypropylene were used. Thereafter, the above-mentioned nonaqueous electrolyte (LiClO₄/PC-DME) was brought into contact with the positive electrode 11 and separator 13 inside positive electrode case 14.

Additionally, the surface of negative electrode 12 opposite to coating layer 17 was brought into contact with the inner bottom surface of negative electrode case 15 made of stainless steel. The both surfaces were compression-bonded to each other.

Negative electrode case 15 to which negative electrode 12 was compression-bonded was mounted on positive electrode case 14 provided with positive electrode 11. Thus, coating layer 17 of negative electrode 12 and positive electrode 11 were disposed to face each other with separator 13 interposed therebetween. Gasket 16 (made of polypropylene) was attached onto the periphery of negative electrode case 15, and caulked with positive electrode case 14. Thus, coin-type lithium primary battery 10 (outer diameter: 20 mm, thickness 1.6 mm) as shown in FIGURE was fabricated. Note here that fabrication of lithium primary battery 10 was carried out in dry air having a dew point of −50° C. or lower.

### Example 2

A lithium primary battery was obtained in the same manner as in Example 1 except that a laminated body of nonwoven fabric made of polypropylene (thickness: 80 μm, mass per unit area: 22 g/m²) and a microporous film made of polyethylene (thickness: 9 μm) was used as separator 13. Note here that separator 13 was disposed such that the nonwoven fabric made of polypropylene was brought into contact with positive electrode 11.

### Comparative Example 1

A lithium primary battery was obtained in the same manner as in Example 1 except that a lithium metal plate punched in a circle having a diameter of 16 mm (the same negative electrode 12 as in Example 1 except that no coating layer was formed) was used as the negative electrode.

### Comparative Example 2

A lithium primary battery was obtained in the same manner as in Example 2 except that a lithium metal plate punched in a circle having a diameter of 16 mm (the same negative electrode 12 as in Example 1 except that no coating layer was formed) was used as the negative electrode.

### <Evaluation of Physical Properties of Lithium Primary Battery>

Lithium primary batteries of Examples 1 to 2 and Comparative Examples 1 to 2 were measured for internal resistance (IR) and closed-circuit voltage (CCV) as follows. For measurement, five samples each were used in Examples and Comparative Examples Results are shown in Table 1.

### 1-1. Evaluation of Initial Characteristics

Immediately after fabrication, lithium primary batteries were subjected to a preliminary discharge at a constant current of 4 mA for 30 minutes. After preliminary discharge, the lithium primary batteries were subjected to aging for 1 day in an environment at 60° C. to stabilize the open circuit voltage (OCV). Thereafter, CCV was measured at room temperature when a pulse discharge was carried out at internal resistance (IR) at 1 kHz and a constant current of 2 mA for one second.

1-2. Evaluation of Characteristics after Storage at High Temperature

Immediately after fabrication, the lithium primary batteries were subjected to a preliminary discharge at a constant current of 4 mA for 30 minutes, and then stored for 100 days in an environment at 60° C. Internal resistance (IR) at 1 kHz and CCV were measured after storage for 60 days (denoted by d in Table) and after storage for 100 days (denoted by d in Table).

TABLE 1

| | | | IR (Ω) | | | CCV (V) | | |
|---|---|---|---|---|---|---|---|---|
| | | | | Storage at | | | Storage at | |
| | Coating | | Initial | 60° C. | | Initial | 60° C. | |
| | layer | Separator | stage | 60 d | 100 d | stage | 60 d | 100 d |
| Ex. 1 | AB | non-woven | 7 | 9 | 10 | 3.53 | 3.46 | 3.42 |
| | | fabric | | | | | | |
| Ex. 2 | AB | non-woven | 7 | 17 | 21 | 3.53 | 3.37 | 3.34 |
| | | fabric + | | | | | | |
| | | microporous | | | | | | |
| | | film | | | | | | |
| Co. | Not | non-woven | 15 | — | — | 3.43 | — | — |
| Ex. 1 | pro- | fabric | | | | | | |
| | vided | | | | | | | |
| Co. | Not | non-woven | 15 | 32 | 35 | 3.45 | 3.02 | 3.01 |
| Ex. 2 | pro- | fabric + | | | | | | |
| | vided | microporous | | | | | | |
| | | film | | | | | | |

Ex. = Example
Co. Ex. = Comparative Example

In Examples 1 and 2 including a coating layer, increase in IR after storage at high temperature was suppressed, and large degradation in CCV was not observed. In particular, in Example 1 in which only nonwoven fabric was used as the separator, the increase in IR was more suppressed. In Comparative Example 1 in which a coating layer was not provided and only nonwoven fabric was used as the separator, a short circuit was clearly observed after storage for 60 days. Therefore, CCV was not be able to be measured. Furthermore, in Comparative Example 2 in which a coating layer was not provided and a nonwoven fabric and a microporous film were used as the separator, no short circuit was observed but increase in internal resistance was great and significant degradation of CCV was observed.

Furthermore, in Examples 1 and 2, open-circuit voltages (OCV) were measured by the same method as mentioned above after storage for 3 days, 10 days, 60 days, and 100 days, respectively. Results are shown in Table 2.

TABLE 2

| | | | OCV (V) | | | | |
|---|---|---|---|---|---|---|---|
| | Coating | | Initial | Storage at 60° C. | | | |
| | layer | Separator | stage | 3 d | 10 d | 60 d | 100 d |
| Ex. 1 | AB | non-woven | 3.60 | 3.57 | 3.57 | 3.55 | 3.54 |
| | | fabric | | | | | |
| Ex. 2 | AB | non-woven | 3.60 | 3.57 | 3.57 | 3.55 | 3.54 |
| | | fabric + | | | | | |
| | | microporous | | | | | |
| | | film | | | | | |

In Examples 1 and 2, significant degradation was not obtained also in OCV.

Furthermore, for reference, lithium primary batteries using MnO₂ as the positive electrode active material (Reference Examples 1 to 4) were produced, and open-circuit voltages (OCV) thereof were measured as mentioned above. Results are shown in Table 3.

### Reference Example 1

A lithium primary battery was obtained in the same manner as in Example 1 except that a positive electrode produced in the following procedure was used.

### Production of Positive Electrode

Manganese dioxide (MnO₂), Ketjen black, and polytetrafluoroethylene were mixed in the mass ratio of 85:10:5. Water was added to the resultant mixture and sufficiently kneaded so as to obtain a positive electrode material mixture. A positive electrode was produced in the same manner as in Example 1 except that the thus obtained positive electrode material mixture was used.

### Reference Example 2

A lithium primary battery was obtained in the same manner as in Example 2 except that the positive electrode produced in Reference Example 1 was used.

### Reference Example 3

A lithium primary battery was obtained in the same manner as in Comparative Example 1 except that the positive electrode produced in Reference Example 1 was used.

### Reference Example 4

A lithium primary battery was obtained in the same manner as in Comparative Example 2 except that a positive electrode produced in Reference Example 1 was used.

TABLE 3

| | | | OCV (V) | | | | |
|---|---|---|---|---|---|---|---|
| | Coating | | Initial | Storage at 60° C. | | | |
| | layer | Separator | stage | 3 d | 10 d | 60 d | 100 d |
| Ref. 1 | AB | non-woven | 3.21 | 3.26 | 3.30 | 3.26 | 3.24 |
| | | fabric | | | | | |
| Ref. 2 | AB | non-woven | 3.21 | 3.27 | 3.29 | 3.26 | 3.25 |
| | | fabric + | | | | | |
| | | microporous | | | | | |
| | | film | | | | | |
| Ref. 3 | Not | non-woven | 3.21 | 3.26 | 3.29 | 3.27 | 3.25 |
| | provided | fabric | | | | | |
| Ref. 4 | Not | non-woven | 3.21 | 3.27 | 3.30 | 3.26 | 3.24 |
| | provided | fabric + | | | | | |
| | | microporous | | | | | |
| | | film | | | | | |

Ref = Reference Example

Table 3 shows that when MnO₂ is used as the positive electrode active material, regardless of the presence or absence of a coating layer and types of separators, significant reduction of voltage due to storage at a high temperature was not observed, showing that no short circuit occurs.

Furthermore, in Reference Examples 3 and 4, a closed-circuit voltage (CCV) was measured as mentioned above. Results are shown in Table 4.

TABLE 4

| | | | OCV (V) | | |
|---|---|---|---|---|---|
| | Coating | | Initial | Storage at 60° C. | |
| | layer | Separator | stage | 60 d | 100 d |
| Ref. 3 | Not | non-woven fabric | 3.15 | 2.81 | 2.45 |
| | provided | | | | |
| Ref. 4 | Not | non-woven fabric + | 3.16 | 2.82 | 2.37 |
| | provided | microporous film | | | |

It is shown from Tables 1 and 4 that in Examples 1 and 2 using Fe₂(SO₄)₃ as the positive electrode active material, increase in the internal resistance is more suppressed and a CCV value is higher at the initial stage and after storage at high temperature, as compared with Reference Examples 3 and 4 using MnO₂ as the positive electrode active material.

Furthermore, from these experiments, even when Fe₂(SO₄)₃ was used as the positive electrode active material, when a coating layer is provided, as in the battery using MnO₂ as the positive electrode active material, a short circuit after storage at high temperature can be suppressed, and it is shown that excellent high-temperature storage characteristics can be obtained.

In the above-mentioned Examples, lithium metal was used as the negative electrode, but even when the negative electrode is a lithium alloy, the same effect as in Examples mentioned above can be obtained.

### INDUSTRIAL APPLICABILITY

A lithium primary battery of the present invention is suitably used as, for example, a power source for electronic devices such as a portable device and an information device, particularly as a main power source and a memory backup power source for vehicle-mounted electronic devices which are assumed to be used in a high temperature environment.

### REFERENCE MARKS IN THE DRAWINGS

10 battery
11 positive electrode
12 negative electrode
13 separator
14 positive electrode case
15 negative electrode case
16 gasket
17 coating layer

1. A lithium primary battery comprising:
a negative electrode including at least one of metal lithium and a lithium alloy;
a positive electrode including a positive electrode active material;
a separator interposed between the negative electrode and the positive electrode; and
a nonaqueous electrolyte;
wherein
the positive electrode active material includes Fe2(SO4)3,
the negative electrode has a coating layer on a facing surface facing the positive electrode, and
the coating layer includes a powder or fibrous material.

2. The lithium primary battery of claim 1, wherein the powder or fibrous material includes a conductive material.

3. The lithium primary battery of claim 2, wherein the conductive material includes a carbon material.

4. The lithium primary battery of claim 3, wherein the carbon material is at least one selected from the group consisting of carbon black and graphite.

5. The lithium primary battery of claim 1, wherein the separator includes a nonwoven fabric.
